(19) United States
(12) Patent Application Publication
(10) Pub. No.: US 2009/0316741 A1
(43) Pub. Date: Dec. 24, 2009

(54) Temperature control apparatus and optical transmission device using same

(75) Inventor: Manabu Watanabe, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/385,266

(22) Filed: Apr. 2, 2009

(30) Foreign Application Priority Data
Jun. 20, 2008 (JP) 2008-161964

(51) Int. Cl. H01S 3/04; G05D 23/00

(52) U.S. Cl. 372/34; 700/299

(57) ABSTRACT

A temperature control apparatus that performs stabile temperature control operation, besides avoiding generation of unwanted noise. A thermo-control device cools or heats an object according to a supply current that a thermo-control driver provides according to a specified control voltage. A temperature sensor observes the temperature of the object. A variable voltage controller varies the control voltage such that the observed temperature of the object will be a specified reference temperature. The variable voltage controller begins to operate in alternate setting mode when the control voltage is expected to enter a voltage range in which the thermo-control driver could malfunction. During that mode, the variable voltage controller outputs a first control voltage and a second control voltage alternately at predetermined intervals. The first and second control voltages are malfunction-free voltages near the malfunction-prone voltage range.

### CROSS-REFERENCE TO RELATED APPLICATIONS

This application is based upon and claims the benefits of priority of the prior Japanese Patent Application No. 2008-161964, filed on Jun. 20, 2008, the entire contents of which are incorporated herein by reference.

### FIELD

The embodiments discussed herein relate to an apparatus for controlling temperature and an apparatus for transmitting optical signals.

### BACKGROUND

Optical transmitters use semiconductor laser devices as an optical signal source, along with oscillation control to produce a desired fixed wavelength. Distributed feedback (DFB) laser is widely used for this purpose. The oscillation wavelength of a DFB laser is determined by Bragg grating formed in an active region of the semiconductor chip. Altering the temperature of Bragg grating causes variations in its refractive index. For this reason, variations of the device's operating temperature affect the wavelength of the produced laser beam.

Because of its temperature dependence, the DFB laser is used together with a temperature regulating mechanism. Temperature control may be implemented by using, for example, a modularized Peltier-effect device (known as a thermo-electric cooler, or TEC) to cool or heat a DFB laser device. The temperature of the DFB laser device can be regulated by controlling the current of this TEC module.

Generally, a TEC driver that produces a pulse-width modulated (PWM) voltage output is used to supply a current to a TEC. FIG. 14 illustrates such a TEC driver 50 and its surrounding circuits configured to drive a TEC 60. The illustrated TEC driver 50 has two voltage input terminals, IN+ and IN−, to receive control voltages. The illustrated TEC driver 50 also has two signal output terminals, PWM and H/C (Heat/Cool). One voltage input terminal IN+ is connected to a variable voltage source 53a that provides a variable voltage Vin(+). Connected to the other voltage input terminal IN− is a constant voltage source 53b that provides a fixed voltage Vin(−). The PWM terminal is connected to one end of a coil L. The other end of this coil L is connected to one end of a capacitor C0, as well as to one control terminal c1 of the TEC 60. The H/C terminal is connected to the other end of the capacitor C0, as well as to the other control terminal c2 of the TEC 60.

The TEC driver 50 outputs a pulse-width modulated voltage (PWM signal) from its PWM terminal, the ripples of which are smoothed out by an LC filter formed from the above-noted coil L and capacitor C0. The resulting average DC voltage m is applied to one control terminal c1 of the TEC 60. The other control terminal c2 of the TEC 60 is driven to either a high-level voltage or low-level voltage provided as an H/C signal from the TEC driver 50 through its from H/C terminal. The voltage difference between those two control terminals c1 and c2 causes a current flow in the TEC 60. This current is referred to as TEC current, or ITEC.

FIG. 15 is a graph illustrating TEC current, where the vertical axis represents the magnitude of ITEC and the horizontal axis represents a differential input voltage Vd (=Vin(+)−Vin(−)) applied to the TEC driver 50. The graph of FIG. 15 plots several operating points of the TEC driver 50 or TEC 60. Operating point B is where Vin(+)=Vin(−); there is no voltage difference between Vin(+) and Vin(−). No TEC current flows in the TEC 60 at this operating point B. Operating point C is where Vin(+) exceeds Vin(−), or Vin(+)>Vin(−). The TEC 60 is brought to this operating point C when H/C is low, at which a TEC current flows in the direction from control terminal c1 to control terminal c2. The symbol ITEC(+) refers to a TEC current in this direction.

As operating point C moves to the right, away from operating point B (i.e., as Vin(+) increases further above Vin(−)), the absolute value of differential input voltage Vd becomes larger, thus resulting in an increased ITEC(+). As operating point C moves toward operating point B (i.e., as Vin(+) approaches Vin(−)), the absolute value of differential input voltage Vd becomes smaller, thus resulting in a decreased ITEC(+).

Operating point A, on the other hand, is where Vin(+) is lower than Vin(−), or Vin(+)<Vin(−). The TEC 60 is brought to this operating point A when H/C signal is high, at which a TEC current flows in the direction from control terminal c2 to control terminal c1. The symbol ITEC(−) refers to a TEC current in this direction.

As operating point A moves to the left, away from operating point B (i.e., as Vin(+) decreases further below Vin(−)), the absolute value of differential input voltage Vd becomes larger, thus resulting in an increased ITEC(−).

As operating point A moves toward operating point B (i.e., as Vin(+) approaches Vin(−)), the absolute value of differential input voltage Vd becomes smaller, thus resulting in a decreased ITEC(−).

FIGS. 16 to 18 illustrate how the TEC driver 50 operates. Specifically, FIG. 16 gives five operating points, and FIGS. 17 and 18 illustrate PWM and H/C signals at each of those operating point to explain how the TEC 60 behaves in its transition from cooling mode to heating mode.

Referring now to FIGS. 16 and 17, the H/C signal goes low when Vin(+)>Vin(−). The PWM signal has a higher duty cycle for a greater difference Vin(+)−Vin(−), i.e., for a larger distance of the operating point with respect to point B. Here, in the context of PWM waveform, the term “duty cycle” refers to the ratio of the high-state duration to the period of a PWM signal. That is, a higher duty cycle means a longer high-state duration.

At operating point C2 (see upper half of FIG. 17), the LC filter smoothes PWM signal s1, and the resulting average voltage m1 is applied to one control terminal c1 of the TEC 60, while H/C signal drives the other control terminal c2 to low. Accordingly, a TEC current ITEC2(+) flows in the TEC 60 as a result of the voltage difference Va1 between the average voltage m1 and the low H/C signal.

At operating point C1 (see lower half of FIG. 17), PWM signal s2 has a smaller duty cycle than at operating point C2 because of the lower Vin(+) and consequent reduction in the difference between Vin(+) and Vin(−) at operating point C1. This PWM signal s2 is smoothed by the LC filter, and the resulting average voltage m2 is applied to one control terminal c1 of the TEC 60, while H/C signal drives the other control terminal c2 to low. A TEC current ITEC1(+) flows in the TEC 60 as a result of the voltage difference Va2 between the average voltage m2 and the low H/C signal. This ITEC1(+) is smaller than ITEC2(+) since Va2 is smaller than Va1.

The larger the current ITEC(+) becomes, the more the TEC 60 can cool the object to which it is attached. As the operating point moves away from B to C1 and then to C2, the magnitude of ITEC(+) increases, and the TEC 60 offers more cooling power accordingly. As the operating point moves back from C2 to C1 and then to B, the magnitude of ITEC(+) decreases, and the TEC 60 offers less cooling power accordingly.

Referring to FIGS. 16 and 18, the H/C signal goes high when Vin(+)<Vin(−). The PWM signal has a lower duty cycle for a greater difference Vin(+)−Vin(−), i.e., for a larger distance of the operating point with respect to point B. This lower duty cycle means a longer duration of the low state of the PWM signal.

At operating point A1 (see upper half of FIG. 18), the LC filter smoothes PWM signal s3, and the resulting average voltage m3 is applied to one control terminal c1 of the TEC 60, while H/C signal drives the other control terminal c2 to high. Accordingly, a TEC current ITEC1(−) flows in the TEC 60 as a result of the voltage difference Vb1 between the average voltage m3 and the high H/C signal.

At operating point A2 (see lower half of FIG. 18), PWM signal s4 has a smaller duty cycle (or a longer low-state duration) than at operating point A1 because of the greater difference between Vin(+) and Vin(−) at operating point A2. The LC filter smoothes this PWM signal s4, and the resulting average voltage m4 is applied to one control terminal c1 of the TEC 60, while H/C signal drives the other control terminal c2 to high. Accordingly, a TEC current ITEC2(−) flows in the TEC 60 as a result of the voltage difference Vb2 between the average voltage m4 and the high H/C signal.

The larger the current ITEC(−) becomes, the more the TEC 60 can heat the object to which it is attached. As the operating point moves away from B to A1 and then to A2, the magnitude of ITEC(−) increases, and the TEC 60 offers more heating power accordingly. As the operating point moves back from A2 to A1 and then to B, the magnitude of ITEC(−) decreases, and the TEC 60 offers less heating power accordingly.

The above-described cooling and heating operations of the TEC 60 are summarized in FIG. 19. As can be seen from this FIG. 19, the TEC driver 50 switches the direction (or polarity) of TEC current by changing H/C signal levels depending on which one of the control voltages Vin(+) and Vin(−) is higher than the other. The TEC driver 50 further controls the amount of TEC current in accordance with the amplitude of a differential control voltage, i.e., the absolute difference between Vin(+) and Vin(−).

Japanese Laid-open Patent Publication No. 11-126939 (1999), paragraph Nos. 0027 to 0059, FIG. 1, offers a conventional TEC-related technique. Specifically, this literature proposes a method for reducing power consumption of a TEC device that is used to control temperature of an LD chip. The proposed method stops supplying current to the TEC device when the ambient temperature is within the LD chip's guaranteed operating temperature range.

As an example of conventional PWM technique, Japanese Laid-open Patent Publication No. 2005-341736, paragraph Nos. 0022 to 0025, FIG. 1, proposes a method for suppressing noise. The proposed method uses exclusive OR and logical AND operations of two PWM signals to control the driver.

The above-described TEC driver 50 may have problems when it stays in the vicinity of operating point B, as in the case of transition from cooling to heating or vice versa. The difference between Vin(−) and Vin(+) is small in the vicinity of operating point B, and that condition could cause shoot-through current within the TEC driver 50. Also, the PWM and H/C signals could behave irregularly in that condition, resulting in a malfunction of the TEC driver 50 and consequent switching noise.

Shoot-through current occurs as follows. FIG. 20 depicts a situation where shoot-through current may occur. As discussed earlier, H/C signal goes low when Vin(+)>Vin(−), and the high-state duration of PWM signal decreases as Vin(+) approaches Vin(−). When Vin(+)<Vin(−), H/C signal goes high, and the low-state duration of PWM signal increases as Vin(+) moves away from Vin(−). A large voltage fluctuation is produced at the point of Vin(+)≈Vin(−), causing shoot-through current on a power supply line (from VDD to GND) in the TEC driver 50.

FIG. 21 illustrates how shoot-through current occurs in the TEC driver 50. The TEC driver 50 includes P-channel field effect transistors (FETs) 51 and 53 and N-channel FETs 52 and 54, together with gate drivers 55 and 56 to drive those FETs 51 to 54, in the neighborhood of PWM and H/C terminals.

The gate of FET 51 is connected to one drive output of the gate driver 55. The gate of FET 52 is connected to the other drive output of the same gate driver 55. The source of FET 51 is connected to power supply VDD, together with the source of FET 53. The drains of FETs 51 and 52 are connected together with the PWM terminal. The source of FET 52 is connected to the ground (GND), as is the source of FET 54. The gate of FET 53 is connected to one drive output of another gate driver 56. The gate of FET 54 is connected to the other drive output of the gate driver 56. The drains of FETs 53 and 54 are connected together with the H/C terminal.

Shoot-through current i1 flows from VDD to GND via the source of FET 51, the source of FET 53, the drain of FET 53, H/C terminal, the drain of FET 54, and the source of FET 54 in that order. Shoot-through current i2 flows from VDD to GND via the source of FET 51, drain of FET 51, PWM terminal, drain of FET 52, source of FET 52, and source of FET 54 in that order.

The aforementioned irregularity of PWM and H/C signals occurs as follows. FIG. 22 to FIG. 24 illustrate output waveforms of the TEC driver 50. Specifically, FIG. 22 illustrates output waveforms at operating point A in a domain where Vin(+)<Vin(−). More specifically, FIG. 22 depicts a stead-state operation of the TEC driver 50 in heating mode, where a current ITEC(−) flows as a result of the illustrated PWM signal and high H/C signal. FIG. 23 then illustrates output waveforms at operating point C in another domain where Vin(+)>Vin(−). FIG. 23 represents a stead-state operation of the TEC driver 50 in cooling mode, where an ITEC(+) flows as a result of the illustrated PWM signal and low H/C signal.

FIG. 24, on the other hand, illustrates output waveforms at operating point B where Vin(+)≈Vin(−). The state of Vin(+)≈Vin(−) continues for a while, during which the H/C signal alternates between high and low, and the PWM signal exhibits irregular duty cycle patterns.

Repetitive voltage fluctuations are observed, along with shoot-through current on the power supply line.

The Shoot-through current previously illustrated in FIG. 20 is only a transitional phenomenon at the moment that Vin(+) crosses Vin(−), in which case the H/C and PWM signals exhibit no particular irregularity in their behaviors. Unlike the case of FIG. 20, Vin(+) stays in the vicinity of Vin(−) for a certain period in the case of FIG. 24. During this period, the H/C and PWM signals change irregularly, and shoot-through current flows frequently inside the TEC driver 50.

Conventionally, TECs have been used mostly for cooling a CPU or similar devices. They have also been applied in recent years to optical transmitters for the purpose of temperature control of laser diodes (LD). In the latter application, the TEC 60 is supposed to offer both cooling and heating functions by switching directions of TEC current flow according to the ambient temperature. It is sometimes necessary for the TEC driver 50 to control the TEC 60 in a neutral way (i.e., neither cool nor heat), while restricting the TEC current as much as possible for a certain duration. The TEC driver 50 encounters this situation when switching its operation from cooling to heating or vice versa.

As discussed earlier, operating point B is where the above-noted transitions actually take place. At this operating point B, however, the TEC driver 50 may experience problems such as internal shoot-through current and distorted PWM pattern. Accordingly, an attempt to regulate the TEC current to zero would result in noise on a power supply line of the TEC driver 50, and that noise could lead to malfunction of, or produce unwanted effects on, other control circuits and monitor devices that share the same power supply line in the optical transmitter.

To avoid generation of noise, the TEC current may be fixed to a non-zero value A. Even if a small value is selected for this A, supplying such a non-zero TEC current continuously to the TEC 60 will cause some amount of temperature shift. That is, the TEC 60 will be cooled if A is positive and warmed if A is negative. This method is unable to maintain the temperature of the object.

### SUMMARY

According to an aspect of the present invention, there is provided a temperature control apparatus for controlling temperature of an object. This apparatus includes the following elements: a thermo-control device, located close to the object, to cool or heat the object according to a current supplied thereto; a thermo-control driver to control the current of the thermo-control device according to a control voltage; a temperature sensor to observe the temperature of the object; and a variable voltage controller to vary the control voltage such that the observed temperature of the object will be a specified reference temperature, so as to achieve temperature regulation of the object. The variable voltage controller begins to operate in alternate setting mode when the control voltage is expected to enter a voltage range in which the thermo-control driver could malfunction. During that alternate setting mode, the variable voltage controller supplies the thermo-control driver with an alternating control voltage that alternates between a first control voltage and a second control voltage at predetermined intervals. Here, the first control voltage is a malfunction-free voltage near a lower limit of the voltage range, and the second control voltage is another malfunction-free voltage near an upper limit of the voltage range.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A and 1B illustrate a temperature control apparatus and its features according to an embodiment of the present invention;

FIG. 2 illustrates a more specific configuration of a temperature control apparatus;

FIG. 3 illustrates how a variable voltage controller operates;

FIG. 4 illustrates output waveforms of a TEC driver at operating points B(+) and B(−);

FIG. 5 is a flowchart illustrating how to determine control voltage values;

FIG. 6 illustrates an optical transmission device according to another embodiment;

FIG. 7 is a flowchart illustrating a temperature control process;

FIG. 8 is a flowchart illustrating another temperature control process;

FIG. 9 illustrates temperature variations of TEC at alternate setting mode;

FIG. 10 illustrates another optical transmission device;

FIG. 11 illustrates how the operating point of a TEC driver moves when laser drive current varies;

FIG. 12 illustrates yet another optical transmission device;

FIG. 13 summarizes how the operating point moves and laser drive current changes;

FIG. 14 illustrates a circuit surrounding a TEC driver;

FIG. 15 illustrates a TEC current;

FIGS. 16 to 18 illustrate how a TEC driver operates;

FIG. 19 summarizes cooling and heating operations under TEC control;

FIG. 20 depicts a situation where shoot-through current may occur;

FIG. 21 illustrates how shoot-through current occurs in the TEC driver; and

FIGS. 22 to 24 illustrate output waveforms of a TEC driver.

### DESCRIPTION OF EMBODIMENT(S)

Embodiments of the present invention will now be described below with reference to the accompanying drawings, wherein like reference numerals refer to like elements throughout.

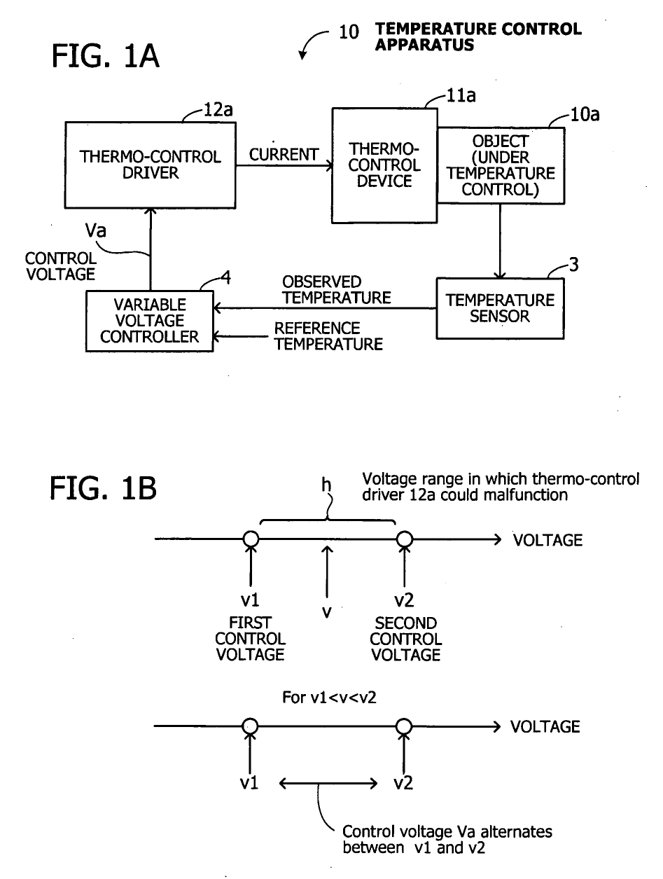

FIG. 1A illustrates a temperature control apparatus according to an embodiment of the present invention. To achieve temperature control of an object 10a, the illustrated temperature control apparatus 10 includes a thermo-control device 11a, a thermo-control driver 12a, a temperature sensor 3, and a variable voltage controller 4.

The thermo-control device 11a is located close to the object 10a to cool or heat the object according to a current supplied to the thermo-control device 11a. The thermo-control driver 12a varies its output current according to a given control voltage Va. The temperature sensor 3 observes the temperature of the object 10a. The variable voltage controller 4 varies the control voltage Va such that the observed temperature of the object 10a will be a specified reference temperature, thereby achieving temperature regulation.

Referring to FIG. 1B, the variable voltage controller 4 may find, during the course of temperature regulation, a control voltage v entering or approaching a voltage range h in which the thermo-control driver 12a could malfunction. If this is the case, the variable voltage controller 4 begins to operate in alternate setting mode to prevent the control voltage from staying in the voltage range h. In this alternate setting mode, the variable voltage controller 4 supplies the thermo-control driver 12a with an alternating control voltage that alternates between a first control voltage v1 and a second control voltage v2 at predetermined intervals. The first control voltage v1 is a malfunction-free voltage near the lower limit of the voltage range h. The second control voltage v2 is a malfunction-free voltage near the upper limit of the voltage range h.

The temperature of the object 10a is affected by variations of the ambient temperature or other external disturbances when it is controlled in the alternate setting mode using particular control voltages v1 and v2. The variable voltage controller 4 may need to set a new control voltage Va to regulate the temperature against such disturbances. If this control voltage Va is equal to or lower than the first control voltage v1, or if it is equal to or higher than the second control voltage value v2, the variable voltage controller 4 exits from the alternate setting mode and returns to its ordinary feedback control mode to regulate the object's temperature.

In other words, the variable voltage controller 4 produces a control voltage Va in different ways depending on a voltage v that is supposed to be supplied to the thermo-control driver 12a. When v≦v1 or v2≦v, the variable voltage controller 4 outputs this v as is. When v1<v<v2, the variable voltage controller 4 outputs, not that voltage v, but v1 and v2 alternately at predetermined intervals.

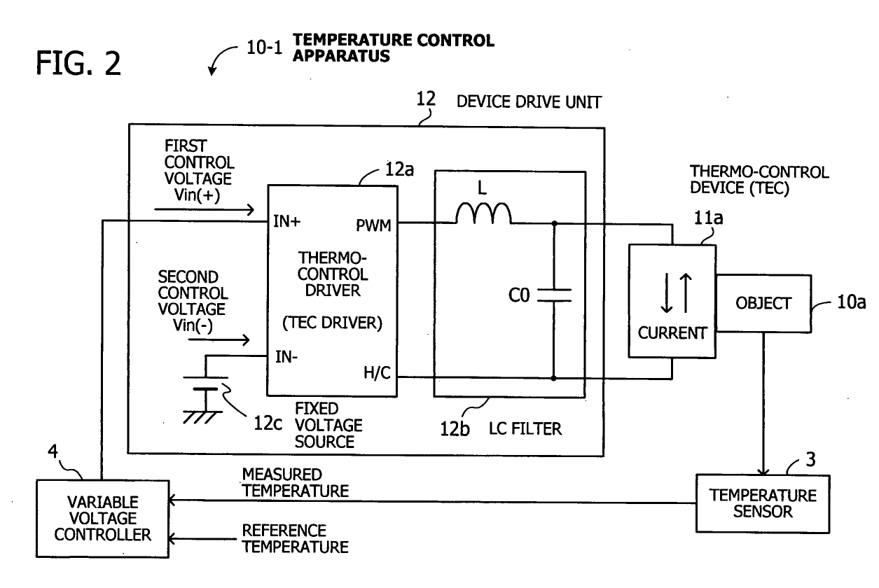

Referring now to FIG. 2 and subsequent drawings, a more specific structure and operation of the above temperature control apparatus will be described below. FIG. 2 illustrates a temperature control apparatus. To control the temperature of an object 10a, this temperature control apparatus 10-1 includes a thermo-control device 11a, a device drive unit 12, a temperature sensor 3, and a variable voltage controller 4.

The thermo-control device 11a is a thermo-electric cooler (TEC), for example. Located close to the object 10a, the thermo-control device 11a (hereafter, TEC 11a) cools or heats it depending on the direction (polarity) of a supply current. The degree of cooling and heating can be varied in accordance with the amount of this supply current. The device drive unit 12 includes a thermo-control driver (or TEC driver) 12a, an LC filter 12b formed from a coil L and a capacitor C0, and a constant voltage source 12c.

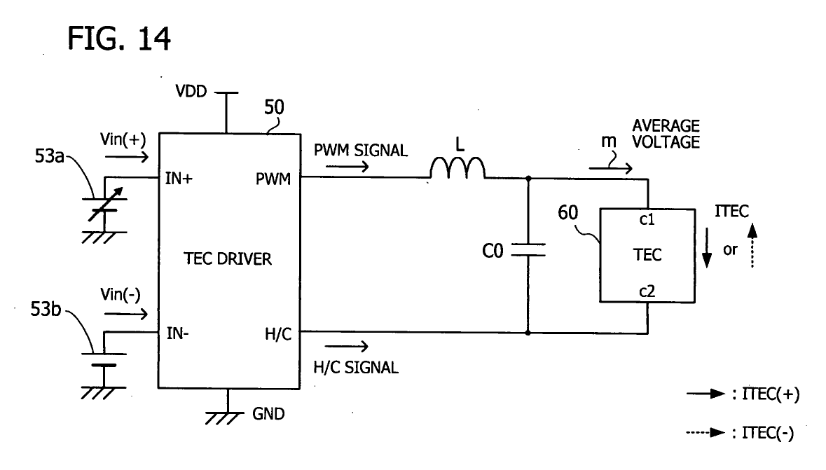

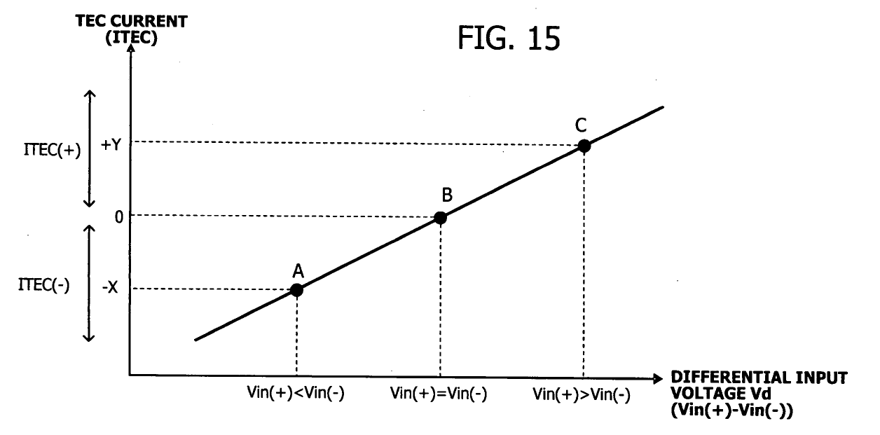

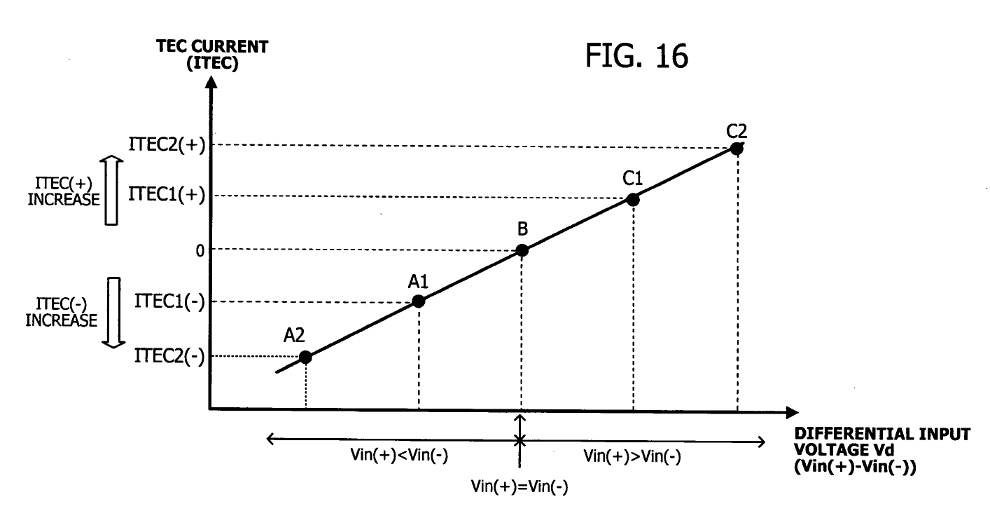

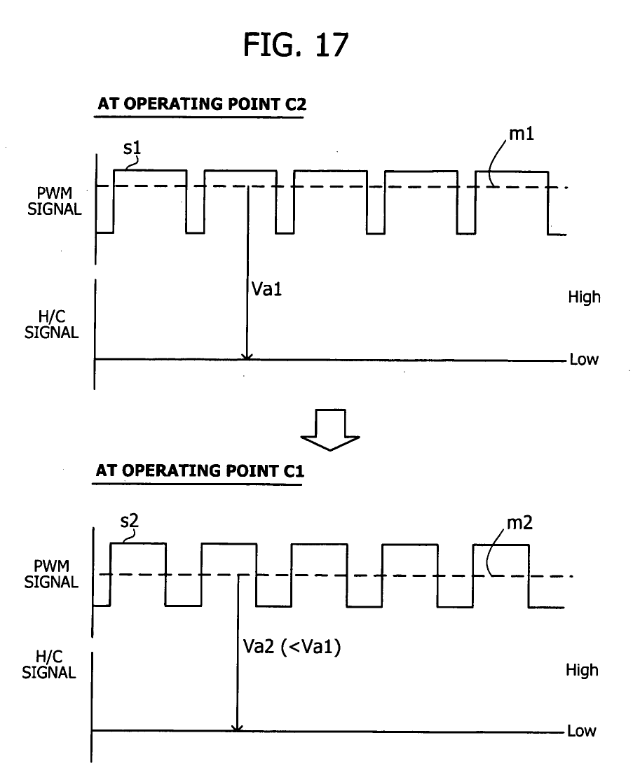

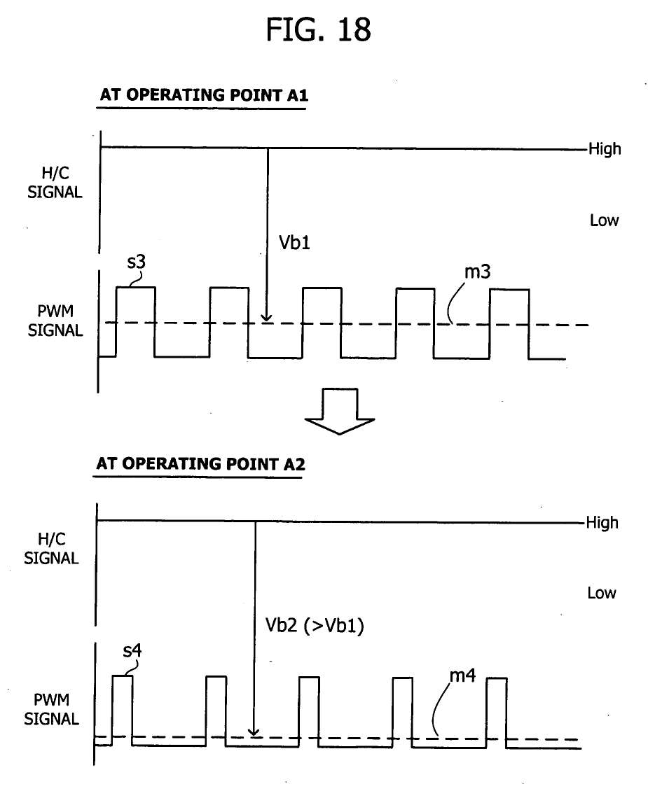

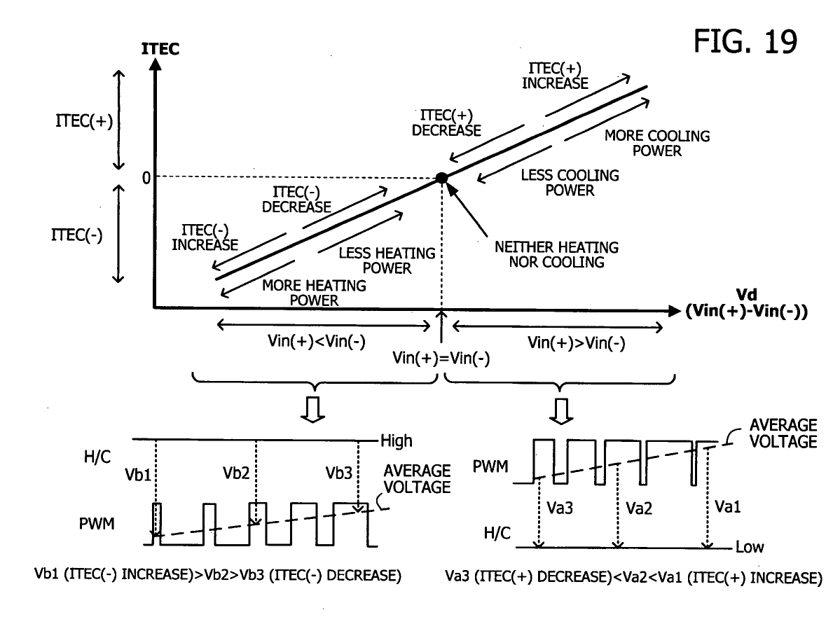

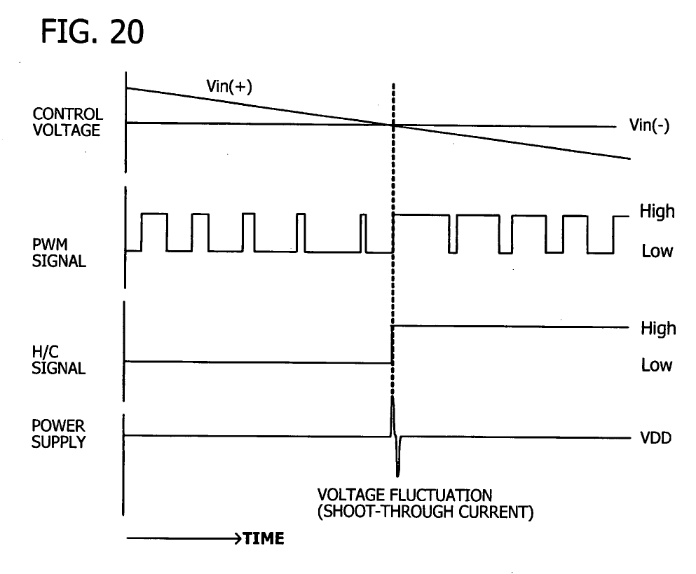

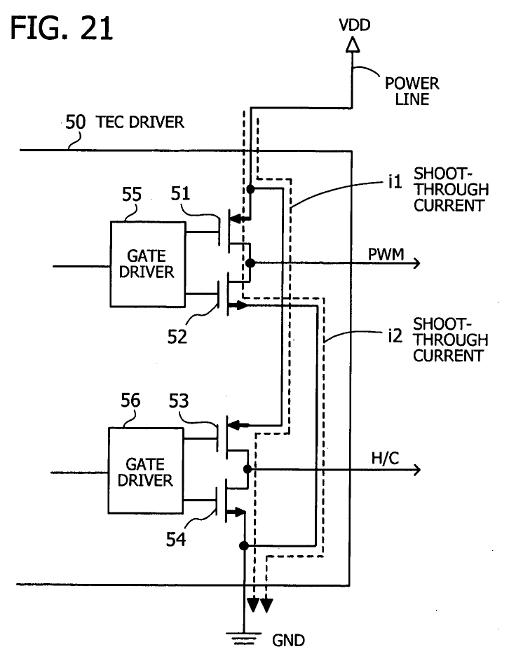

The thermo-control driver 12a is actually a TEC driver circuit and thus referred to hereafter as a TEC driver 12a. This TEC driver 12a receives a first control voltage Vin(+) and a second control voltage Vin(−), the former being variable, the latter being fixed. The TEC driver 12a supplies the TEC 11a with an electric current. The polarity of this current depends on whether Vin(+) is higher than Vin(−), and the amount of this current varies with the difference between Vin(+) and Vin(−). The structure and operation of such TEC, TEC driver, and LC filter have been discussed earlier with reference to FIGS. 14 to 19, which will not be repeated here.

The temperature sensor 3 observes the temperature of the object 10a under control. The variable voltage controller 4 varies the first control voltage Vin(+) such that the observed temperature will reach a desired reference temperature and be maintained at that temperature, thereby achieving temperature regulation.

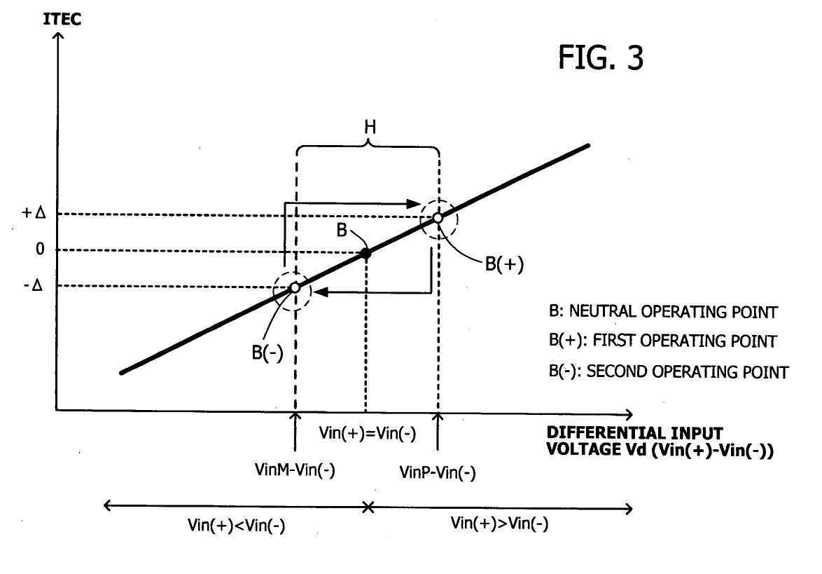

FIG. 3 illustrates how the variable voltage controller 4 operates. The vertical axis represents TEC current (ITEC), and the horizontal axis represents differential input voltage Vd, Vin(+)−Vin(−), supplied to the TEC driver 12a.

The output current of the TEC driver 12a becomes zero when Vin(+) coincides with Vin(−). This operating point is referred to as a neutral operating point, or operating point B. The TEC driver 12a could malfunction in a certain range around operating point B. This range is thus referred to as a malfunction range H.

A first operating point B(+) is defined in a first domain of control voltages where Vin(+) is higher than Vin(−). In the first domain, the cooling power decreases as the TEC driver 12a approaches operating point B. Stated in reverse, the cooling power increases as the TEC driver 12a moves away from operating point B. Preferably, the first operating point B(+) is located in the vicinity of the malfunction range H mentioned above. VinP represents the value of Vin(+) at this operating point B(+).

Likewise, a second operating point B(−) is defined in a second domain of the control voltages where Vin(+) is lower than Vin(−). In the second domain, the heating power decreases as the TEC driver 12a approaches operating point B. Stated in reverse, the heating power increases as the TEC driver 12a moves away from operating point B. Preferably, the second operating point B(−) is defined in the vicinity of the malfunction range H mentioned above. VinM represents the value of Vin(+) at this operating point B(−).

During the course of temperature regulation, the variable voltage controller 4 may find the control voltage Vin(+) entering or approaching the malfunction range H. If this is the case, the variable voltage controller 4 begins to operate in alternate setting mode to prevent the control voltage Vin(+) from staying in the malfunction range H. In the alternate setting mode, the variable voltage controller 4 supplies the TEC driver 12a with a control voltage Vin(+) that alternates between VinP at the first operating point B(+) and VinM at operating point B(−) at predetermined intervals.

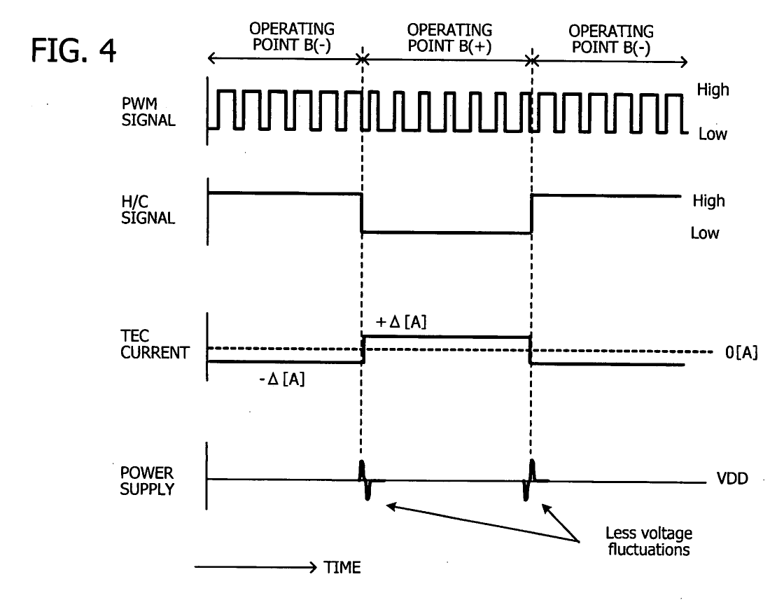

FIG. 4 illustrates output waveforms of the TEC driver 12a at operating points B(+) and B(−). During the time when it operates at operating point B(−), the device drive unit 12 outputs a high H/C signal since Vin(+) is smaller than Vin(−). The PWM signal has a high duty cycle (i.e., short low-state duration). As depicted in FIG. 3, operating point B(−) is located on the left of the malfunction range H around operating point B. Because of its close proximity to operating point B, the potential difference between H/C and PWM terminals of the TEC driver 12a is very small. Accordingly, a little TEC current ITEC(−) with a magnitude of −Δ flows from H/C terminal to PWM terminal (or from terminal c2 to terminal c1 of the TEC illustrated in FIG. 14).

During the time when it operates at operating point B(+), the device drive unit 12 outputs a low H/C signal since Vin(+) is smaller than Vin(−). The PWM signal has a low duty cycle (i.e., short high-state duration). As depicted in FIG. 3, operating point B(+) is located on the right of the malfunction range H around operating point B. Because of its close proximity to operating point B, the potential difference between H/C and PWM terminals of the TEC driver 12a is very small. Accordingly, a little TEC current ITEC(+) with a magnitude of +A flows from PWM terminal to H/C terminal (or from terminal c1 to terminal c2 of the TEC illustrated in FIG. 14).

As can be seen from the above, the present embodiment sets the operating point of the TEC driver 12a alternately to B(+) and B(−) when Vin(+) is about to enter a malfunction range H of the TEC driver 12a. That is, the variable voltage controller 4 controls its output Vin(+) in such a way that two set voltages VinP and VinM corresponding to operating points B(+) and B(−) will be supplied alternately to the voltage input terminal IN+ of the TEC driver 12a. The proposed control technique makes it possible to prevent the TEC driver 12a from experiencing excessive shoot-through current. As FIG. 4 illustrates, the power line exhibits little transient voltage fluctuations at operating points B(+) and B(−). The present embodiment also suppresses irregular behaviors of PWM and H/C signals, thus preventing the TEC driver 12a from malfunctioning.

The temperature of the object 10a is affected by variations of the ambient temperature or other external disturbances when it is controlled at operating points B(+) and B(−) in alternate setting mode. The variable voltage controller 4 may need to set a new control voltage Vin(+) to regulate the temperature against such disturbances. If this control voltage Vin(+) is equal to or lower than VinM, or if it is equal to or higher than VinP, then the variable voltage controller 4 exits from alternate setting mode and returns to its ordinary feedback control mode to regulate the object's temperature by using the control voltage Vin(+) as is.

In a transition period between cooling and heating operations, it is necessary to control the TEC 11a in a neutral way (i.e., neither cool nor heat), while restricting the TEC current as much as possible for a certain duration. The control voltage Vin(+) is likely to approach the malfunction range H of the TEC driver 12a in such conditions. Conventional TEC drivers could malfunction or produce noise when their Vin(+) is set for zero or almost zero TEC current. Unlike those conventional drivers, the TEC driver 12a in the proposed temperature control apparatus 10-1 operates in a stable way because its operating point will alternate between B(+) and B(−) so as to prevent Vin(+) from entering the malfunction range H.

While the above-described variable voltage controller 4 is configured to activate alternate setting mode upon detection of Vin(+) entering the malfunction range H, the preferred embodiments are not limited to that configuration. For example, one embodiment may be configured to enter to or exit from alternate setting mode in response to a command from some upper-level control device that determines whether to switch the TEC 11a from cooling mode to heating mode and vice versa.

As noted above, the alternate setting mode switches between two operating points B(+) and B(−) at predetermined intervals. Preferably, the interval is shorter than a time constant of the TEC 11a, which is part of a transfer function representing how the TEC 11a produces a temperature change in response to a current supplied thereto. Specifically, the thermal output of the TEC 11a has some time delay from its electric current input. This delay is, for example, in the order of seconds (e.g., 0.5 to 5 seconds). Accordingly, the variable voltage controller 4 switches operating points at intervals in the order of micro seconds or milliseconds. For example, the TEC driver 12a stays at operating point B(+) for t microseconds, then moves to operating point B(−) and stays there for t microseconds, and then goes back to operating point (B+). The TEC driver 12a repeats this until it exits from the alternate setting mode. The resulting current of the TEC 11a neither cools nor heats the object, producing no temperature changes. The TEC current is, in effect, zero.

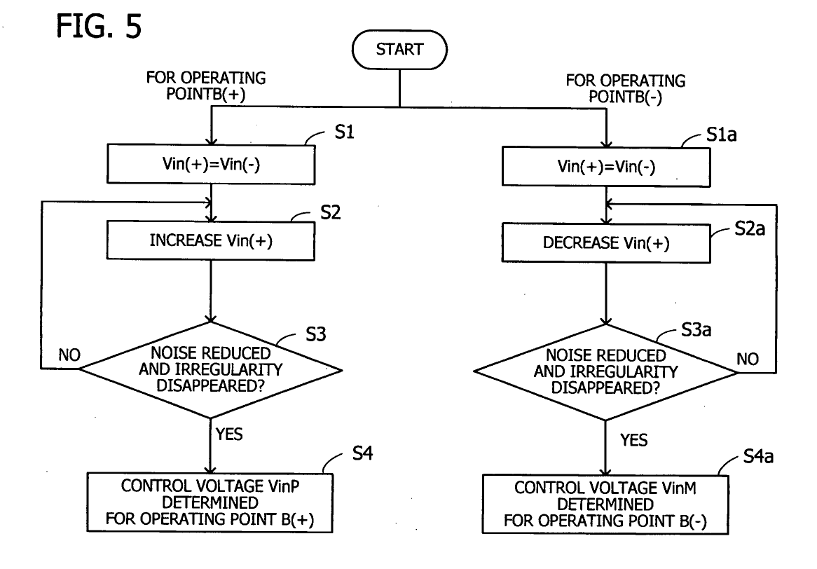

Referring now to the flowchart of FIG. 5, the following section describes how the present embodiment determines operating points B(+) and B(−). As noted earlier, the operating points B(+) and B(−) are defined by their respective control voltage values VinP and VinM. FIG. 5 is a flowchart illustrating how VinP and VinM are determined.

(S1) This step adjusts Vin(+) to Vin(−). The TEC driver 12a is now at operating point B, where Vin(+) equals Vin(−). At this operating point B, the TEC driver 12a experiences power line noise and irregular behaviors of PWM and H/C signals.

(S2) This step increases Vin(+) a bit at a time, while observing power line noise and PWM and H/C signal behaviors. That is, the TEC driver 12a leaves the operating point B and moves its operating point rightward (FIG. 3).

(S3) This step determines whether the power line noise has decreased to an acceptable level (e.g., small enough for the circuit components to operate correctly). This step also determines whether the irregularity of PWM and H/C signals has disappeared. If both test results are positive, then the present process proceeds to step S4. Otherwise, the process returns to step S2 for another trial.

(S4) Now that Vin(+) has reached a minimum voltage at which the power line noise is small enough and the PWM and H/C signals exhibit no particular irregularity. VinP is thus set to this voltage.

(S1a) This step adjusts Vin(+) to Vin(−).

(S2a) This step decreases Vin(+) a bit at a time, while observing power line noise and PWM and H/C signal behaviors. That is, the TEC driver 12a leaves the operating point B and moves its operating point leftward (FIG. 3).

(S3a) This step determines whether the power line noise has decreased to an acceptable level (e.g., small enough for the circuit components to operate correctly). This step also determines whether the irregularity of PWM and H/C signals has disappeared. If both test results are positive, then the present process proceeds to step S4a. Otherwise, the process returns to step S2a for another trial.

(S4a) Now that Vin(+) has reached a maximum voltage at which the power line noise is small enough and the PWM and H/C signals exhibit no particular irregularity. VinM is thus set to this voltage.

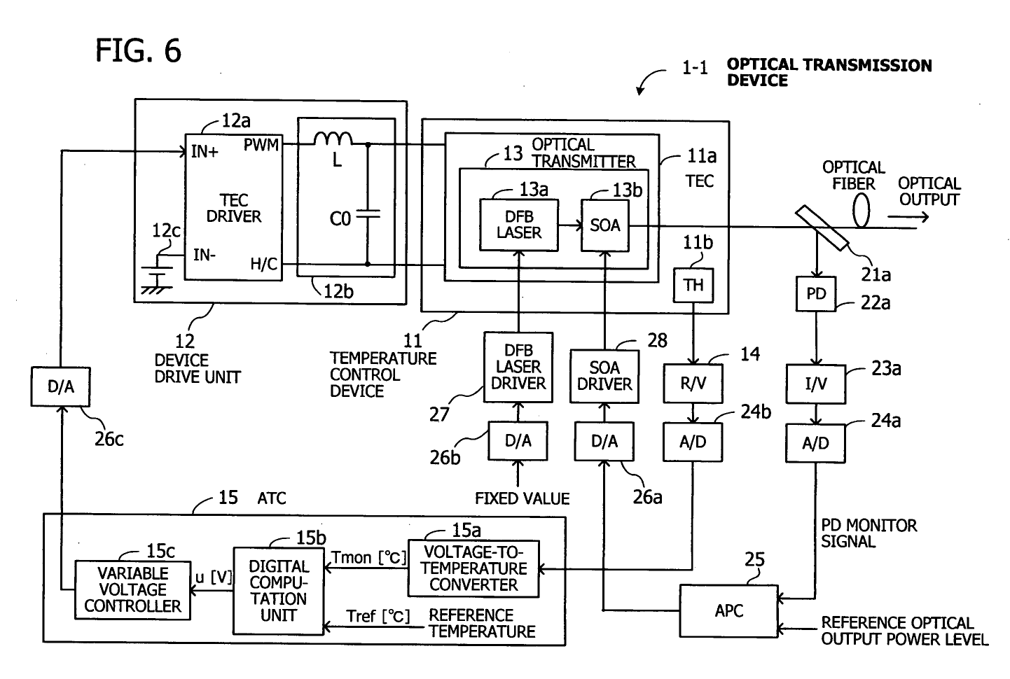

The above-described functions of the temperature control apparatus 10-1 may be applied to an optical transmission device. FIG. 6 illustrates an optical transmission device according to an embodiment of the present invention. The illustrated optical transmission device 1-1 includes a temperature control device 11, a device drive unit 12, an optical transmitter 13, a resistance-to-voltage (R/V) converter 14, an automatic temperature controller (ATC) 15, a splitter 21a, a PD 22a, a current-to-voltage (I/V) converter 23a, analog-to-digital (A/D) converters 24a and 24b, an automatic power controller (APC) 25, digital-to-analog (D/A) converters 26a, 26b, and 26c, a DFB laser driver 27, and a semiconductor optical amplifier (SOA) driver 28.

The temperature control device 11 includes a TEC 11a and a thermistor 11b. The device drive unit 12 includes a TEC driver 12a, an LC filter 12b, and a constant voltage source 12c. The optical transmitter 13 includes a DFB laser 13a and an SOA 13b and is mounted on the TEC 11a. The ATC 15 includes a voltage-to-temperature converter 15a, a digital computation unit 15b, and a variable voltage controller 15c.

The optical transmission device 1-1 produces an optical signal as follows. The DFB laser 13a is supposed to produce an optical output with a predetermined wavelength λ0. Digital data representing a drive current for this purpose is supplied to the D/A converter 26b, which converts the received digital data into an analog signal. Based on this analog signal, the DFB laser driver 27 produces an LD drive current. The LD drive current energizes the DFB laser 13a, thus oscillating a signal light beam. The SOA 13b is driven with an SOA drive current supplied from the SOA driver 28, thus amplifying the signal light beam.

The splitter 21a then divides the signal light beam from the SOA 13b into two beams. One is transmitted to a subsequent device via an optical fiber, while the other is directed to a PD 22a. This PD 22a converts the signal light beam to a photocurrent. The I/V converter 23a converts this photocurrent to an analog voltage. The A/D converter 24a converts the analog voltage to a digital voltage value, which is referred to as a PD monitor signal.

The APC 25 receives the PD monitor signal from the A/D converter 24a and a reference optical output power level that is specified. The APC 25 produces a digital control signal such that the actual power level of the signal light being monitored by the PD 22a will match with the reference optical output power level.

The D/A converter 26a converts the digital control signal received from the APC 25 into an analog signal, based on which the SOA driver 28 produces an SOA drive current to drive the SOA 13b.

In the optical transmission device 1-1 described above, the temperature of the DFB laser 13a is controlled as follows. The temperature of the DFB laser 13a is measured by a thermistor 11b, the electrical resistance of which varies with temperature. The R/V converter 14 converts this temperature-dependent resistance of the thermistor 11b to an analog voltage signal, and the A/D converter 24b then converts it to a digital voltage signal.

Inside the ATC 15, the voltage-to-temperature converter 15a receives the above digital voltage signal from the A/D converter 24b and interprets it into a temperature monitor signal Tmon. The digital computation unit 15b calculates a temperature difference between the temperature monitor signal Tmon and a specified reference temperature Tref. The reference temperature Tref corresponds to a desired reference wavelength λ0 that the DFB laser 13a is supposed to produce. The digital computation unit 15b outputs a temperature voltage signal u (digital value) corresponding to the calculated temperature difference. The temperature control loop operates to reduce this temperature difference as much as possible.

The variable voltage controller 15c determines whether the temperature voltage signal u falls within a malfunction range H, namely, VinM<u<VinP. If this test indicates true, the variable voltage controller 15c outputs VinM and VinP alternately so that the TEC driver 12a will move between two operating points B(+) and B(−) at predetermined intervals. The D/A converter 26c receives such digital control voltage data from the variable voltage controller 15c and converts it into an analog signal for use by the TEC driver 12a.

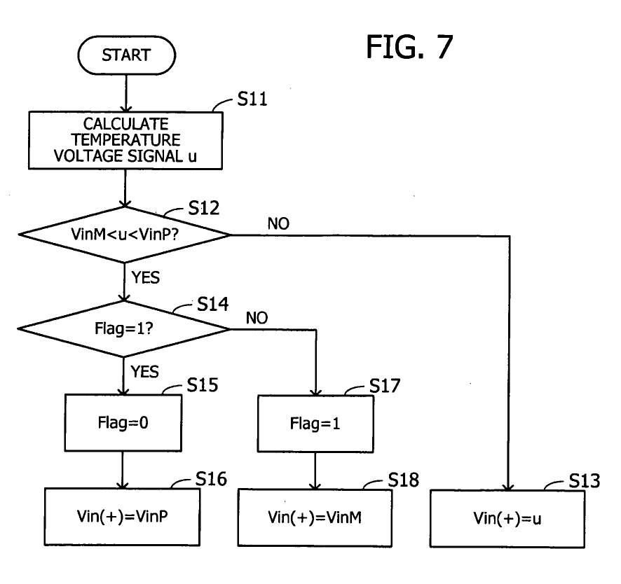

Referring now to the flowchart of FIG. 7, the following will describe how the above optical transmission device 1-1 controls DFB laser temperature.

(S11) The digital computation unit 15b produces a temperature voltage signal u.

(S12) The variable voltage controller 15c determines whether the temperature voltage signal u is greater than the control voltage VinM of operating point B(−), as well as whether the temperature voltage signal u is lower than the control voltage VinP of operating point B(+). If u≦VinM, or if VinP≦u, then the process proceeds to step S13. If VinM<u<VinP, then the process advances to step S14.

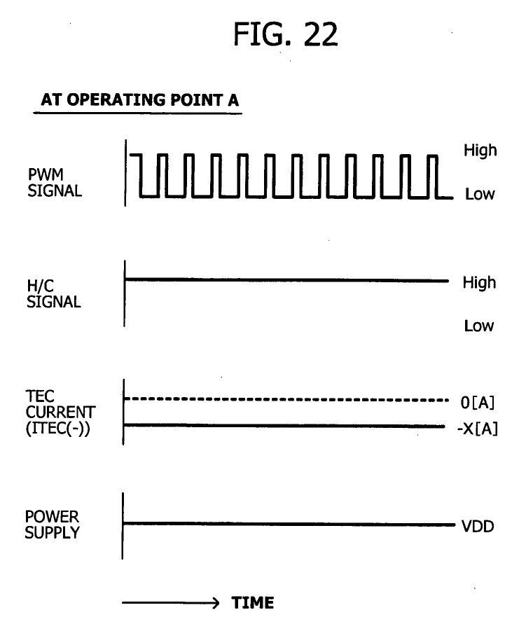

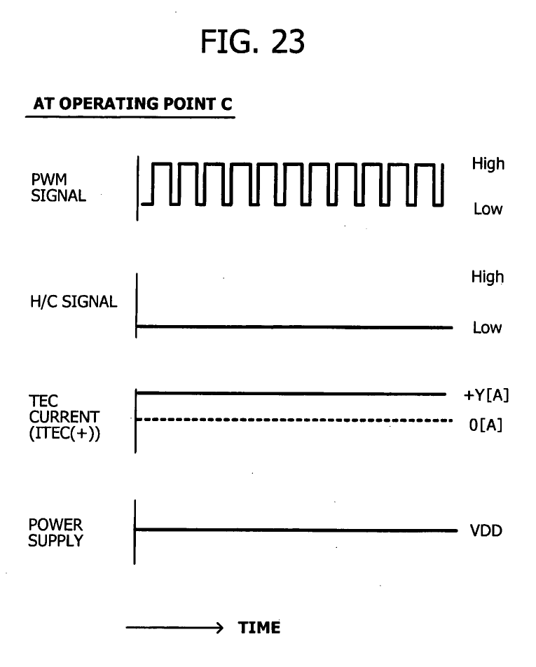

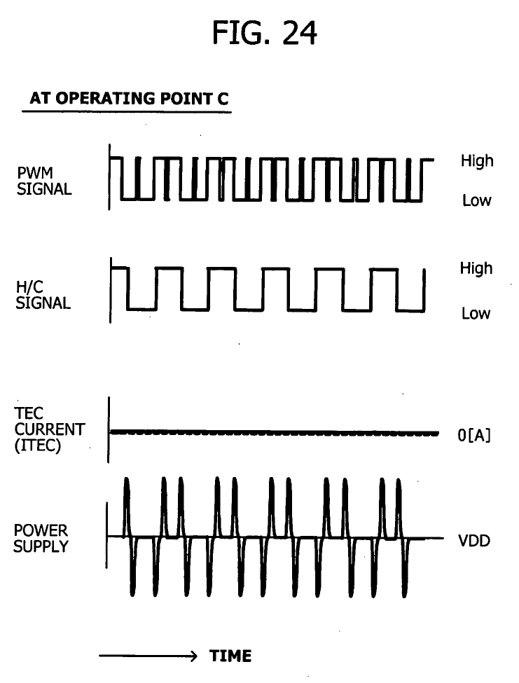

(S13) When u≦VinM, the TEC driver 12a operates steadily as illustrated in FIG. 22. When VinP≦u, the TEC driver 12a operates steadily as illustrated in FIG. 23. The variable voltage controller 15c thus outputs the calculated temperature voltage signal u as is.

(S14) The variable voltage controller 15c tests a flag indicating which operating point to select. Specifically, flag=0 indicates operating point B(−), and flag=1 indicates operating point B(+). If this flag is set to one, the process advances to step S15. Otherwise, the process proceeds to step S17.

(S15) The variable voltage controller 15c reverses the flag to zero to indicate that operating point B(−) will be selected next time.

(S16) The variable voltage controller 15c outputs VinP, thus switching the operating point of the TEC driver 12a to B(+).

(S17) The variable voltage controller 15c reverses the flag to one to indicate that operating point B(+) will be selected next time.

(S18) The variable voltage controller 15c outputs VinM, thus switching the operating point of the TEC driver 12a to B(−).

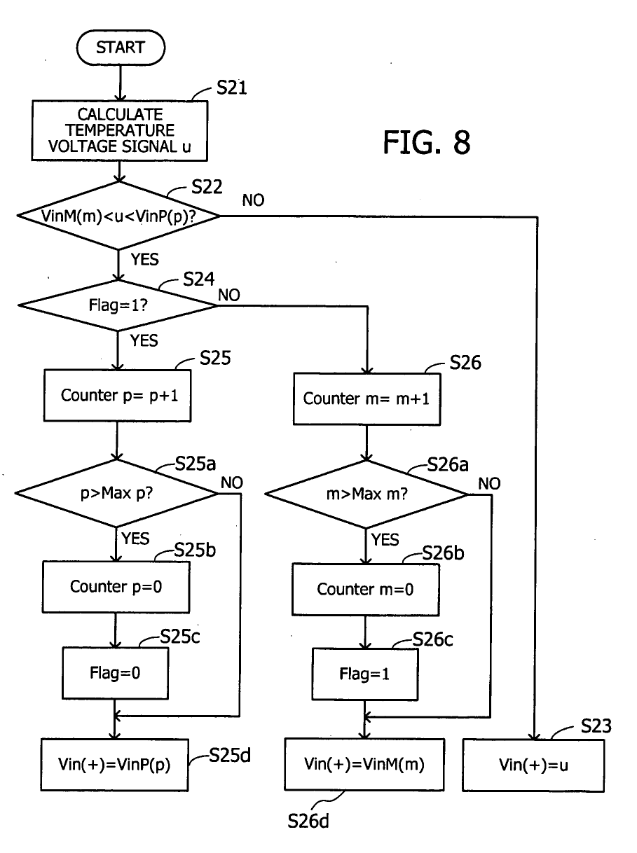

FIG. 8 is a flowchart illustrating a variation of the temperature control process of FIG. 7. The above-described alternate setting mode selects operating points B(+) and B(−) equally. The TEC driver 12a thus operates at B(+), B(−), B(+), B(−), and so on. The variation, on the other hand, selects B(+) p times and then selects B(−) m times. Think of the case where p=3 and m=2, for example. In this case, the TEC driver 12a operates at B(+), B(+), B(+), B(−), B(−), B(+), B(+), B(+), B(−), B(−), and so on. In other words, the TEC driver 12a repeats its operation at B(+) for three cycles and then at B(−) for two cycles. The flowchart of FIG. 8 illustrates this process as follows:

(S21) The digital computation unit 15b produces a temperature voltage signal u.

(S22) The variable voltage controller 15c determines whether the temperature voltage signal u is greater than a control voltage VinM(m) of operating point B(−), as well as whether the temperature voltage signal u is lower than a control voltage VinP(p) of operating point B(+). Here, p is a counter that indicates how many times operating point B(+) has been repeated, or how many times VinP has been output. Likewise, m is a counter that indicates how many times operating point B(−) has been repeated, or how many times VinM has been output. If u≦VinM(m), or if VinP(p)≦u, then the process proceeds to step S23. If VinM(m)<u<VinP(p), then the process advances to step S24.

(S23) When u≦VinM(m), the TEC driver 12a operates steadily as illustrated in FIG. 22. When VinP(p)≦u, the TEC driver 12a operates steadily as illustrated in FIG. 23. The variable voltage controller 15c thus outputs the calculated temperature voltage signal u as is.

(S24) The variable voltage controller 15c tests a flag indicating which operating point to select.

Specifically, flag=0 indicates operating point B(−), and flag=1 indicates operating point B(+). If this flag is set to one, the process advances to step S25. Otherwise, the process branches to step S26.

(S25) The variable voltage controller 15c increments counter p by one.

(S25a) The variable voltage controller 15c determines whether the current count value p is greater than a predetermined maximum count (Max p). If so, the process advances to step S25b. If not, the process skips to step S25d.

(S25b) The variable voltage controller 15c initializes counter p to zero.

(S25c) The variable voltage controller 15c reverses the flag to zero to indicate that operating point B(−) will be selected next time.

(S25d) The variable voltage controller 15c outputs VinP(p), thus switching the operating point of the TEC driver 12a to B(+).

(S26) The variable voltage controller 15c increments counter m by one.

(S26a) The variable voltage controller 15c determines whether the current count value m is greater than a predetermined maximum count (Max m). If so, the process advances to step S26b. If not, the process skips to step S26d.

(S26b) The variable voltage controller 15c initializes counter m to zero.

(S26c) The variable voltage controller 15c reverses the flag to one to indicate that operating point B(+) will be selected next time.

(S26d) The variable voltage controller 15c outputs VinM(m), thus switching the operating point of the TEC driver 12a to B (−).

The above-described control process of FIG. 8 enables the TEC 11a to produce a slight cooling effect or heating effect. This small temperature offset can be achieved by selecting appropriate m and p parameters. Specifically, the DFB laser 13a is slightly cooled in the case of m<p, so that the TEC 11a will operate at operating point B(+) longer than at operating point B(−).

Likewise, the DFB laser 13a is slightly warmed in the case of m>p, so that the TEC 11a will operate at operating point B(−) longer than at operating point B(+). In the case of m=p(=1), the DFB laser 13a will neither be cooled nor heated.

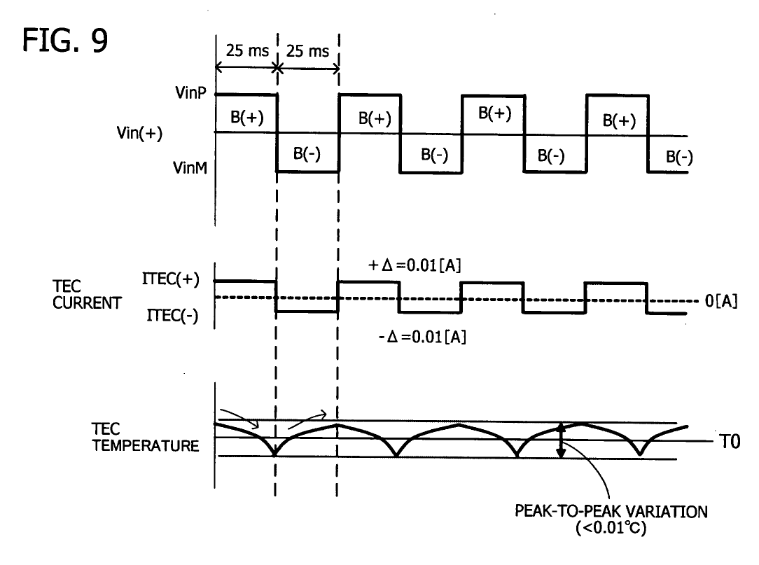

Referring to FIG. 9, the following will now present an experimental result as to how the temperature of the TEC 11a may vary with time when it is driven at operating points B(+) and (B−) in alternate setting mode. FIG. 9 illustrates temperature variations of the TEC 11a at alternate setting mode. The TEC 11a performs thermoelectric conversion at an efficiency of 100° C./A, with a time constant of 5 seconds. In other words, the TEC 11a produces a temperature change of 100° C., five seconds after a drive current of one ampere begins to flow.

The temperature of the TEC 11a decreases when it is driven at operating point B(+) and increases when it is driven at operating point B(−). Since, as noted above, the TEC 11a has a time constant of 5 seconds, its temperature would fall to a temperature corresponding to the control voltage VinP in five seconds if it stayed at operating point B(+).

In the present example, the TEC driver 12a receives alternate VinP and VinM as its Vin(+) input at 25-ms intervals, thus switching operating points between B(+) and B(−). As FIG. 9 indicates, TEC current in this mode is +Δ=−Δ=0.01 [A]. The resulting TEC temperature stays around the reference temperature T0 with a peak-to-peak fluctuation of at most 0.01° C. This 0.01° C. temperature fluctuation is equivalent to variations of 1 pm in terms of the output wavelength of the DFB laser 13a. Wavelength variations in this order would do no harm to the communication.

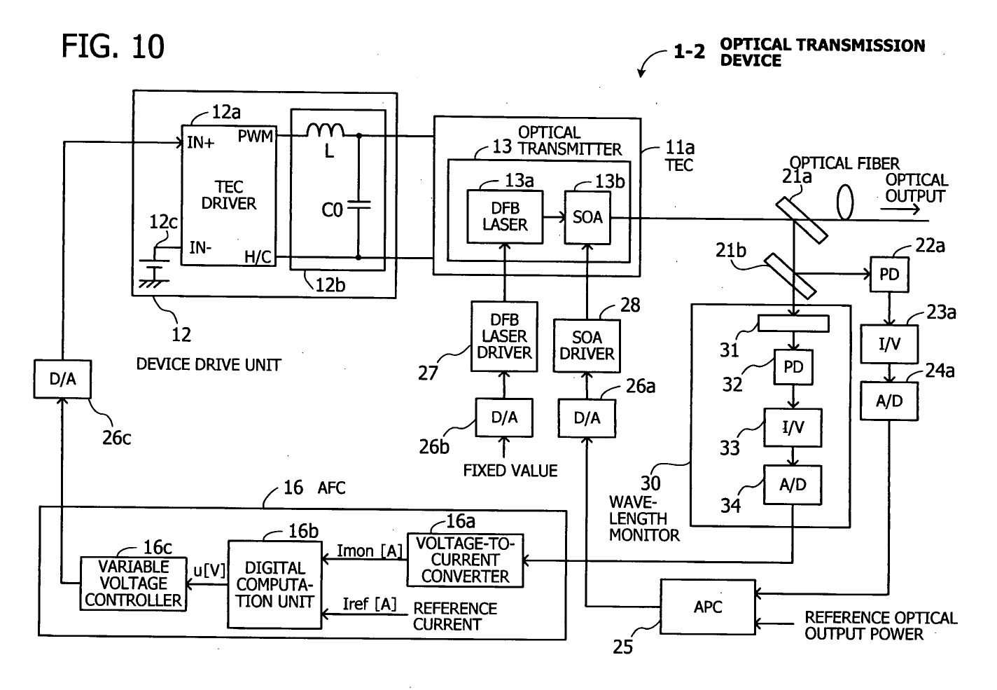

Referring now to FIG. 10, a variation of the above-described optical transmission device will be described below. The optical transmission device 1-1 of FIG. 6 uses ATC techniques to control the temperature of the DFB laser 13a so that the temperature measured with a thermistor 11b will coincide with a desired temperature corresponding to a desired wavelength. This control process uses alternate setting mode when Vin(+) is about to enter a predetermined malfunction range H of the TEC driver 12a.

Unlike the above optical transmission device 1-1, the variation implements an automatic frequency control (AFC) technique to control the output wavelength of the DFB laser 13a such that it will coincide with a reference wavelength. This AFC technique uses alternate setting mode when Vin(+) is expected to enter a predetermined malfunction range H of the TEC driver 12a.

FIG. 10 illustrates an optical transmission device 1-2. This optical transmission device 1-2 includes the following components: a TEC 11a, a device drive unit 12, an optical transmitter 13, an AFC 16, splitters 21a and 21b, a PD 22a, an I/V converter 23a, an A/D converter 24a, an APC 25, D/A converters 26a, 26b, and 26c, a DFB laser driver 27, an SOA driver 28, and a wavelength monitor 30.

The device drive unit 12 includes a TEC driver 12a, an LC filter 12b, and a constant voltage source 12c. The optical transmitter 13 includes a DFB laser 13a and an SOA 13b and is mounted on the TEC 11a. The AFC 16 includes a voltage-to-current converter 16a, a digital computation unit 16b, and a variable voltage controller 16c. The wavelength monitor 30 includes an etalon filter 31, a PD 32, an I/V converter 33, and an A/D converter 34.

The illustrated optical transmission device 1-2 produces an optical output signal in the same way as discussed earlier in FIG. 6. The following description will therefore focus on its temperature control functions. The DFB laser 13a generates a signal light, which is then amplified by an SOA 13b. The splitter 21a splits the amplified signal light into two beams; one is sent to a subsequent device through an optical fiber, and the other is directed to another splitter 21b. The splitter 21b further splits the incoming signal light into two beams; one is sent to a PD 22a for APC, and the other is directed to the wavelength monitor 30.

The etalon filter 31 outputs optical power corresponding to wavelengths of input light. The PD 32 receives the output of the etalon filter 31 and converts it into a photocurrent. The I/V converter 33 then converts this photocurrent into an analog voltage signal. Finally, the A/D converter 34 converts the analog voltage signal into digital form for use by the AFC 16.

Inside the AFC 16, the voltage-to-current converter 16a receives the above-noted digital voltage signal from the A/D converter 34 and converts it to a digital current signal, thus obtaining a wavelength monitor signal Imon. The digital computation unit 16b calculates a difference between the wavelength monitor signal Imon and a specified reference current (or reference wavelength signal) Iref. This reference current Iref corresponds to a desired wavelength that the DFB laser 13a is supposed to produce. The digital computation unit 15b outputs a temperature voltage signal u (digital value) corresponding to the calculated difference. The control loop operates to reduce this difference as much as possible.

The variable voltage controller 16c determines whether the temperature voltage signal u falls within a malfunction range H, namely, VinM<u<VinP. If this test indicates true, the variable voltage controller 16c outputs VinM and VinP alternately so that the TEC driver 12a will move between two operating points B(+) and B(−) at predetermined intervals. The D/A converter 26c receives such digital control voltage data from the variable voltage controller 16c and converts it into an analog signal for use by the TEC driver 12a.

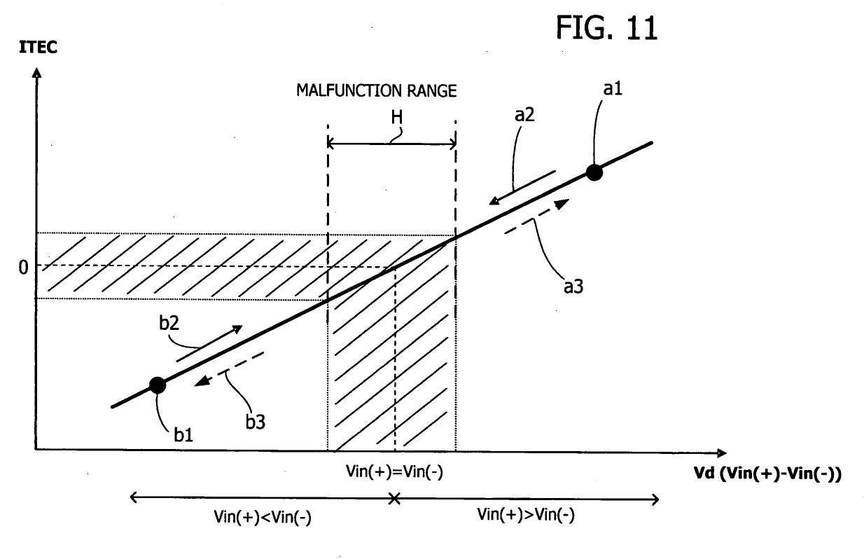

Referring now to FIGS. 11 to 13, the following section will describe yet another embodiment of the present invention. The wavelength of light generated by a DFB laser 13a varies with its drive current. The following embodiment utilizes this current dependency of laser wavelengths to avoid operating point B and its surrounding malfunction range H.

FIG. 11 illustrates how the operating point of a TEC driver 12a moves when laser drive current varies. The vertical axis represents TEC current (ITEC), and the horizontal axis represents differential input voltage Vd, Vin(+)−Vin(−), applied to the TEC driver 12a. The hatched region corresponds to a Vin(+) range of ±50 mV, assuming that Vin(−) is zero and that the full-scale range of Vin(+) is ±1.25 V.

The DFB laser 13a is supposed to generate an optical signal with a specified wavelength λ0. The wavelength of the DFB laser 13a becomes longer as its temperature rises and becomes shorter as its temperature falls. Also, the wavelength becomes longer as the laser drive current increases and becomes shorter as the laser drive current decreases.

The control operations of this embodiment are broadly divided into those in two domains, namely, (A) Vin(+)>Vin(−), and (B) Vin(+)<Vin(−). For each of these domains (A) and (B), the embodiment controls the TEC current and laser drive current in the following way.

(A) In the Domain where Vin(+)>Vin(−):

(a1) When the current ambient temperature of the DFB laser 13a is higher than a specified temperature, the TEC 11a cools the DFB laser 13a. When this cooling is excessive, the DFB laser 13a lowers its output wavelength below λ0.

(a2) The temperature regulation control moves Vin(+) toward Vin(−) to cause the TEC driver 12a to reduce ITEC(+). In other words, the operating point of TEC driver 12a is moved in the direction that the cooling power is reduced.

(a3) Vin(+) may approach the malfunction range H during the above-noted movement of operating point to reduce the cooling power. If this is detected, the temperature regulation control stops moving Vin(+). Instead, the laser drive current is increased to prevent reduction of the wavelength, thereby regulating the wavelength to λ0.

(B) In the Domain where Vin(+)<Vin(−):

(b1) When the current ambient temperature of the DFB laser 13a is lower than a specified temperature, the TEC 11a heats the DFB laser 13a. When this heating is excessive, the DFB laser 13a raises its output wavelength above λ0.

(b2) The temperature regulation control moves Vin(+) toward Vin(−) to cause the TEC driver 12a to reduce ITEC(−). In other words, the operating point of TEC driver 12a is moved in the direction that the heating power is reduced.

(b3) Vin(+) may approach the malfunction range H during the above-noted movement of operating point to reduce the heating power. If this is detected, the temperature regulation control stops moving Vin(+). Instead, the laser drive current is reduced to prevent the wavelength from increasing, thereby regulating the wavelength to λ0.

As can be seen from the above, the present embodiment regulates the wavelength by varying Vin(+) as long as Vin(+) is outside the malfunction range H. When it is found that Vin(+) is entering or approaching the malfunction range H, the present embodiment switches from temperature control to laser drive current control to continue the wavelength regulating operation.

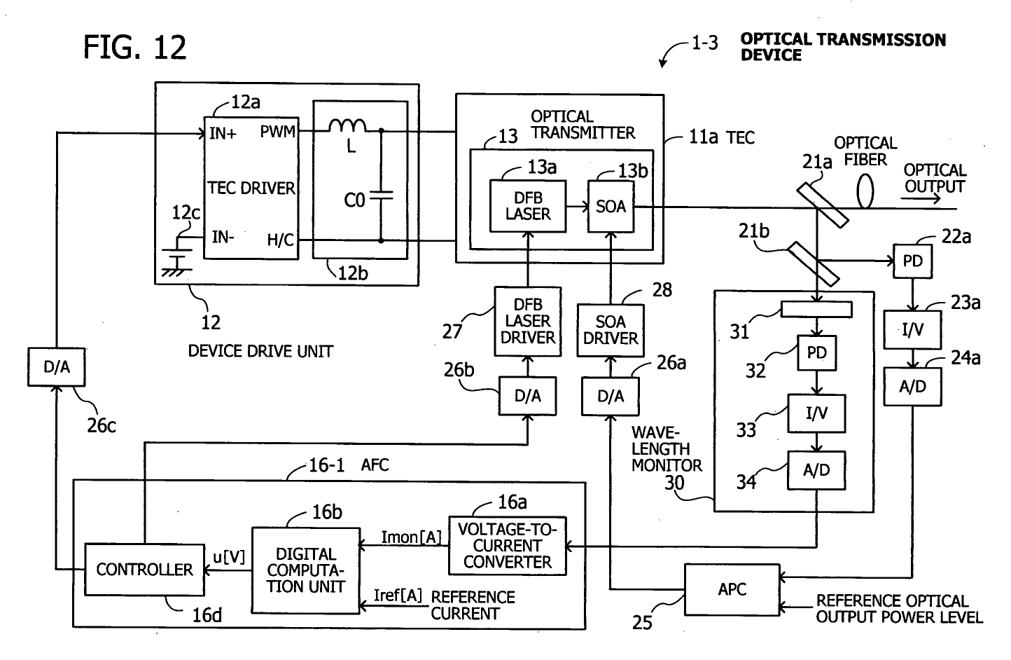

The above-described control functions are depicted in FIG. 11, and FIG. 12 illustrates an optical transmission device including those functions. The illustrated optical transmission device 1-3 is formed from the following components: a TEC 11a, a device drive unit 12, an optical transmitter 13, an AFC 16-1, splitters 21a and 21b, a PD 22a, an I/V converter 23a, an A/D converter 24a, an APC 25, D/A converters 26a, 26b, and 26c, a DFB laser driver 27, an SOA driver 28, and a wavelength monitor 30.

The device drive unit 12 includes a TEC driver 12a, an LC filter 12b, and a constant voltage source 12c. The optical transmitter 13 includes a DFB laser 13a and an SOA 13b and is mounted on the TEC 11a. The AFC unit 16-1 includes a voltage-to-current converter 16a, a digital computation unit 16b, and a controller 16d. The wavelength monitor 30 includes an etalon filter 31, a PD 32, an I/V converter 33, and an A/D converter 34.

The optical transmission device 1-3 is similar to the foregoing optical transmission device 1-2 of FIG. 10, except that it includes a controller 16d in place of the variable voltage controller 16c. Accordingly, the following description will focus on this controller 16d.

The controller 16d is designed to regulate the temperature of the DFB laser 13a by varying Vin(+), as well as to control a drive signal for the DFB laser 13a, such that the wavelength observed by the wavelength monitor 30 will be maintained at a desired wavelength. As discussed in FIG. 11, the controller 16d stops temperature control and switches to laser drive current control when it finds Vin(+) entering or approaching the malfunction range H. Specifically, the controller 16d varies digital data that is supplied to the D/A converter 26b to ensure that the DFB laser 13a produces a signal light with the intended wavelength.

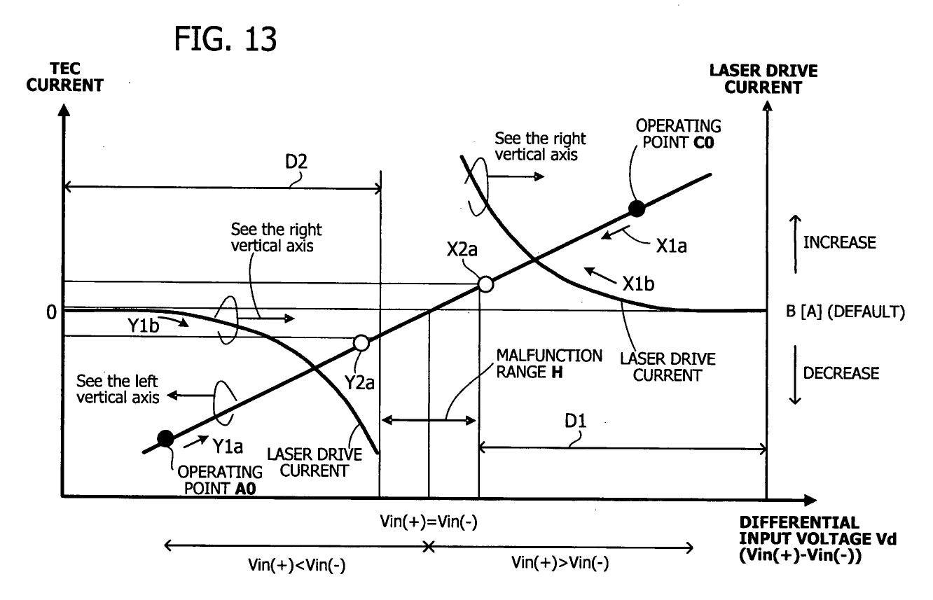

FIG. 13 summarizes how the operating point moves and laser drive current changes. The left vertical axis represents TEC current (ITEC), while the right vertical axis represents laser drive current. The horizontal axis represents differential input voltage Vd, Vin(+)-Vin(−), supplied to the TEC driver 12a.

Suppose now that the TEC driver 12a is at a first operating point C0 in a domain D1 where Vin(+) is higher than Vin(−). Domain D1 is where the cooling power decreases as the TEC driver 12a approaches operating point B, or stated in reverse, the cooling power increases as the TEC driver 12a moves away from operating point B. Note that this domain D1 excludes the malfunction range H of the TEC driver 12a.

In this situation, the output wavelength of the DFB laser 13a may happen to become shorter than a desired reference wavelength. If this is the case, the controller 16d varies Vin(+) toward Vin(−) to reduce the cooling power. Accordingly, the operating point C0 of TEC driver 12a moves in the direction that the cooling power is reduced (as indicated by an arrow X1a in FIG. 13), thereby increasing the laser wavelength. At the same time, the controller 16d raises the laser drive current (as indicated by another arrow X1b in FIG. 13) to avoid operating point B and its vicinity. The operating point C0 will stop at a new operating point X2a before Vd falls in the malfunction range H, since the output wavelength increases as a result of the raised laser drive current.

Suppose now that the TEC driver 12a is at a second operating point A0 in another domain D2 where Vin(+) is lower than Vin(−). Domain D2 is where the heating power decreases as the TEC driver 12a approaches operating point B, or stated in reverse, the heating power increases as the TEC driver 12a moves away from operating point B. Note that this domain D2 excludes the malfunction range H of the TEC driver 12a.

In the above situation, the output wavelength of the DFB laser 13a may become longer than a desired reference wavelength. If this is the case, the controller 16d changes Vin(+) toward Vin(−) to reduce the heating power. Accordingly, the operating point A0 of TEC driver 12a moves in the direction that the heating power is reduced (as indicated by an arrow Y1a in FIG. 13), thereby decreasing the wavelength. At the same time, the controller 16d reduces the laser drive current (as indicated by another arrow Y1b in FIG. 13) to avoid operating point B and its vicinity. The operating point A0 will stop at a new operating point Y2a before Vd falls in the malfunction range H, since the output wavelength decreases as a result of the reduced laser drive current.

As can be seen from the above discussion, the proposed control mechanism prevents the control voltage for a thermo-control driver from entering a voltage range in which the thermo-control driver could malfunction. This feature enables stable operation of temperature regulation control, besides avoiding generation of unwanted noise.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that various changes, substitutions, and alterations could be made hereto without departing from the spirit and scope of the invention.

What is claimed is:

1. An apparatus for controlling temperature of an object, the apparatus comprising:
a thermo-control device, located close to the object, to cool or heat the object according to a current supplied thereto;
a thermo-control driver to control the current of the thermo-control device according to a control voltage;
a temperature sensor to observe the temperature of the object; and
a variable voltage controller to vary the control voltage such that the observed temperature of the object will be a specified reference temperature, so as to achieve temperature regulation of the object;
wherein the variable voltage controller begins to operate in alternate setting mode when the control voltage is expected to enter a voltage range in which the thermo-control driver could malfunction, and during that alternate setting mode, the variable voltage controller supplies the thermo-control driver with an alternating control voltage that alternates between a first control voltage and a second control voltage at predetermined intervals, the first control voltage being a malfunction-free voltage near a lower limit of the voltage range, the second control voltage being another malfunction-free voltage near an upper limit of the voltage range.

2. The apparatus according to claim 1, wherein:
the thermo-control device has a time constant as part of a transfer function representing how the thermo-control device produces a temperature change in response to a current supplied thereto; and
the alternating control voltage alternates between the first and second control voltages at intervals that are shorter than the time constant of the thermo-control device.

3. The apparatus according to claim 1, wherein the variable voltage controller repetitively outputs the first control voltage m times in a row and then the second control voltage p times in a row.

4. An apparatus for controlling temperature of an object, the apparatus comprising:
a thermo-control device, located close to the object, to cool or heat the object depending on polarity of a current supplied thereto, with a variable amount of cooling or heating power that is determined by the amount of the current;
a thermo-control driver, responsive to a first control voltage that is variable and a second control voltage that is fixed, to control the current of the thermo-control device by determining the polarity of the current depending on whether the first control voltage is higher than the second control voltage and varying the amount of the current according to a difference between the first and second control voltages;
a temperature sensor to observe the temperature of the object; and
a variable voltage controller to vary the first control voltage such that the observed temperature of the object will be a specified reference temperature, so as to achieve temperature regulation of the object;
wherein:
a neutral operating point is defined as an operating point of the thermo-control driver at which the first control voltage is set equal to the second control voltage and thus reduces the current to zero;
a malfunction range is defined as a vicinity of the neutral operating point in which the thermo-control driver could malfunction;
a first operating point is defined as an operating point close to the malfunction range, in a domain of operating points in which the first control voltage is higher than the second control voltage, and in which cooling power decreases as the thermo-control driver approaches the neutral operating point, and in which the cooling power increases as the thermo-control driver moves away from the neutral operating point,
a second operating point is defined as an operating point close to the malfunction range, in another domain of operating points in which the first control voltage is lower than the second control voltage, and in which heating power decreases as the thermo-control driver approaches the neutral operating point, and in which the heating power increases as the thermo-control driver moves away from the neutral operating point, and
the variable voltage controller begins to operate in alternate setting mode when the first control voltage is expected to enter the malfunction range and, during that alternate setting mode, causes the thermo-control driver to operate alternately at the first operating point and the second operating point, so as to avoid operation in the malfunction range.

5. The apparatus according to claim 4, wherein:
the thermo-control device has a time constant as part of a transfer function representing how the thermo-control device produces a temperature change in response to a current supplied thereto; and
the variable voltage controller controls the first control voltage to cause the thermo-control driver to operate alternately at the first operating point and the second operating point at intervals that are shorter than the time constant of the thermo-control device.

6. The apparatus according to claim 4, wherein the variable voltage controller controls the first control voltage to cause the thermo-control driver to repetitively operate at the first operating point p times in a row and then at the second operating point m times in a row, during the alternate setting mode.

7. The apparatus according to claim 4, wherein:
the variable voltage controller determines the first operating point by setting the thermo-control driver initially at the neutral operating point, increasing the first control voltage therefrom while observing noise produced in the thermo-control driver, and setting the first operating point to the first control voltage at the moment when the observed noise becomes small enough for other components in the apparatus to operate properly; and
the variable voltage controller determines the second operating point by setting the thermo-control driver initially at the neutral operating point, decreasing the first control voltage therefrom while observing noise produced in the thermo-control driver, and setting the second operating point to the first control voltage at the moment when the observed noise becomes small enough for other components in the apparatus to operate properly.

8. An optical transmission device, comprising:
a semiconductor laser to produce a signal light;
a temperature control device, located close to the semiconductor laser, to control temperature thereof, the temperature control device comprising:
a thermistor with a resistance that varies with the temperature of the semiconductor laser, and
a thermo-control device to cool or heat the semiconductor laser depending on polarity of a current supplied to the thermo-control device, with a variable amount of cooling or heating power that is determined by the amount of the current;
a thermo-control driver, responsive to a first control voltage that is variable and a second control voltage that is fixed, to control the current of the thermo-control device by determining the polarity of the current depending on whether the first control voltage is higher than the second control voltage and varying the amount of the current according to a difference between the first and second control voltages;
a resistance-to-voltage converter to convert the resistance of the thermistor to a voltage signal;
a voltage-to-temperature converter, coupled to the resistance-to-voltage converter, to convert the voltage signal to temperature data indicating an observed temperature of the semiconductor laser;
a computation unit to calculate a temperature difference between the observed temperature and a reference temperature corresponding to a desired wavelength of the semiconductor laser and produce a temperature voltage signal corresponding to the calculated temperature difference; and
a variable voltage controller to vary the first control voltage based on the temperature voltage signal, such that the observed temperature will coincide with the reference temperature;
wherein:
a neutral operating point is defined as an operating point of the thermo-control driver at which the first control voltage is set equal to the second control voltage and thus reduces the current to zero,
a malfunction range is defined as a vicinity of the neutral operating point in which the thermo-control driver could malfunction,
a first operating point is defined as an operating point close to the malfunction range, in a domain of operating points in which the first control voltage is higher than the second control voltage, and in which cooling power decreases as the thermo-control driver approaches the neutral operating point, and in which the cooling power increases as the thermo-control driver moves away from the neutral operating point,
a second operating point is defined as an operating point close to the malfunction range, in another domain of operating points in which the first control voltage is lower than the second control voltage, and in which heating power decreases as the thermo-control driver approaches the neutral operating point, and in which the heating power increases as the thermo-control driver moves away from the neutral operating point, and
the variable voltage controller begins to operate in alternate setting mode when the first control voltage is expected to enter the malfunction range and, during that alternate setting mode, causes the thermo-control driver to operate alternately at the first operating point and the second operating point, so as to avoid operation in the malfunction range.

9. The optical transmission device according to claim 8, wherein:
the thermo-control device has a time constant as part of a transfer function representing how the thermo-control device produces a temperature change in response to a current supplied thereto; and
the variable voltage controller controls the first control voltage to cause the thermo-control driver to operate alternately at the first operating point and the second operating point at intervals that are shorter than the time constant of the thermo-control device.

10. The optical transmission device according to claim 8, wherein the variable voltage controller controls the first control voltage to cause the thermo-control driver to repetitively operate at the first operating point p times in a row and then at the second operating point m times in a row, during the alternate setting mode.

11. The optical transmission device according to claim 8, wherein:
the variable voltage controller determines the first operating point by setting the thermo-control driver initially at the neutral operating point, increasing the first control voltage therefrom while observing noise produced in the thermo-control driver, and setting the first operating point to the first control voltage at the moment when the observed noise becomes small enough for other components in the apparatus to operate properly; and
the variable voltage controller determines the second operating point by setting the thermo-control driver initially at the neutral operating point, decreasing the first control voltage therefrom while observing noise produced in the thermo-control driver, and setting the second operating point to the first control voltage at the moment when the observed noise becomes small enough for other components in the apparatus to operate properly.

12. An optical transmission device, comprising:
a semiconductor laser to produce a signal light;
a thermo-control device, located close to the semiconductor laser, to cool or heat the semiconductor laser depending on polarity of a current supplied to the thermo-control device, with a variable amount of cooling or heating power that is determined by the amount of the current;
a thermo-control driver, responsive to a first control voltage that is variable and a second control voltage that is fixed, to control the current of the thermo-control device by determining the polarity of the current depending on whether the first control voltage is higher than the second control voltage and varying the amount of the current according to a difference between the first and second control voltages;
a wavelength monitor to monitor a wavelength of the signal light produced by the semiconductor laser and produce a wavelength monitor signal representing the wavelength;
a computation unit to calculate a difference between the wavelength monitor signal and a reference wavelength signal corresponding to a desired wavelength of the semiconductor laser and produce a temperature voltage signal corresponding to the calculated difference; and
a variable voltage controller to vary the first control voltage based on the temperature voltage signal, such that the wavelength monitor signal will coincide with the reference wavelength signal;
wherein:
a neutral operating point is defined as an operating point of the thermo-control driver at which the first control voltage is set equal to the second control voltage and thus reduces the current to zero,
a malfunction range is defined as a vicinity of the neutral operating point in which the thermo-control driver could malfunction,
a first operating point is defined as an operating point close to the malfunction range, in a domain of operating points in which the first control voltage is higher than the second control voltage, and in which cooling power decreases as the thermo-control driver approaches the neutral operating point, and in which the cooling power increases as the thermo-control driver moves away from the neutral operating point,
a second operating point is defined as an operating point close to the malfunction range, in another domain of operating points in which the first control voltage is lower than the second control voltage, and in which heating power decreases as the thermo-control driver approaches the neutral operating point, and in which the heating power increases as the thermo-control driver moves away from the neutral operating point, and
the variable voltage controller begins to operate in alternate setting mode when the first control voltage is expected to enter the malfunction range and, during that alternate setting mode, causes the thermo-control driver to operate alternately at the first operating point and the second operating point, so as to avoid operation in the malfunction range.

13. An optical transmission device, comprising:
a semiconductor laser energized by a drive power signal to produce a signal light;
a thermo-control device, located close to the semiconductor laser, to cool or heat the semiconductor laser depending on polarity of a current supplied to the thermo-control device, with a variable amount of cooling or heating power that is determined by the amount of the current;
a thermo-control driver, responsive to a first control voltage that is variable and a second control voltage that is fixed, to control the current of the thermo-control device by determining the polarity of the current depending on whether the first control voltage is higher than the second control voltage and varying the amount of the current according to a difference between the first and second control voltages;
a wavelength monitor to monitor a wavelength of the signal light produced by the semiconductor laser and produce a wavelength monitor signal representing the wavelength;
a computation unit to calculate a difference between the wavelength monitor signal and a reference wavelength signal corresponding to a desired wavelength of the semiconductor laser and produce a temperature voltage signal corresponding to the calculated difference; and
a controller to vary the first control voltage based on the temperature voltage signal, as well as varying the drive power signal of the semiconductor laser, such that the wavelength monitor signal will coincide with the reference wavelength signal;
wherein:
a neutral operating point is defined as an operating point of the thermo-control driver at which the first control voltage is set equal to the second control voltage and thus reduces the current to zero,
a malfunction range is defined as a vicinity of the neutral operating point in which the thermo-control driver could malfunction, and
the controller varies the drive power signal for the semiconductor laser as the first control voltage approaches the malfunction range.

14. The optical transmission device according to claim 13, wherein:
a first operating point is defined as an operating point outside the malfunction range, in a domain of operating points in which the first control voltage is higher than the second control voltage, and in which cooling power decreases as the thermo-control driver approaches the neutral operating point, and in which the cooling power increases as the thermo-control driver moves away from the neutral operating point;
the controller moves the first operating point in a direction that the cooling power is reduced, by decreasing the first control voltage toward the second control voltage, if it is indicated that the semiconductor laser cooled by the thermo-control device at the first operating point produces a wavelength shorter than the desired wavelength;
the controller raises the drive power signal to increase the wavelength if it is found during the movement of the first operating point that the first control voltage is approaching the malfunction range;
a second operating point is defined as an operating point close to the malfunction range, in another domain of operating points in which the first control voltage is lower than the second control voltage, and in which heating power decreases as the thermo-control driver approaches the neutral operating point, and in which the heating power increases as the thermo-control driver moves away from the neutral operating point;
the controller moves the second operating point in a direction that the heating power is reduced, by increasing the first control voltage toward the second control voltage, if it is indicated that the semiconductor laser heated by the thermo-control device at the second operating point produces a wavelength longer than the desired wavelength; and
the controller reduces the drive power signal to decrease the wavelength if it is found during the movement of the second operating point that the first control voltage is approaching the malfunction range.
